(19) United States
(12) Patent Application Publication
(10) Pub. No.: US 2024/0188193 A1
(43) Pub. Date: Jun. 6, 2024

(54) Smart heating controller of DC heating device

(71) Applicants: Min ja KIM, Yangju-si (KR); SP CARE INDUSTRY CO.,Ltd, Yangju-si (KR)

(72) Inventors: Min ja KIM, Yangju-si (KR); Hwa Jin LEE, Bucheon-si (KR)

(21) Appl. No.: 18/282,598

(22) PCT Filed: Jan. 6, 2022
(86) PCT No.: PCT/KR2022/000202

§ 371 Date: Sep. 18, 2023

(30) Foreign Application Priority Data
Mar. 23, 2021 (KR) 10-2021-0037138

(51) Int. Cl. H05B 3/56; H05B 1/02

(52) U.S. Cl. CPC H05B 3/56; H05B 1/0252; H05B 2203/035

(57) ABSTRACT

A smart heating controller for a DC powered heating device that can control the temperature accurately and prevent a local overheating by use of a heat sensing wire using a temperature sensitive insulating resin is provided. A heating cable of the heating device includes: a heating wire covered with a temperature sensitive insulating resin and configured to be heated by the DC power source; and a heat sensing wire on which the temperature sensitive insulating resin is spirally wound on an exterior thereof, wherein the heating controller is configured to: alternatingly have a heating period, in which the heating wire is heated by supplying DC power to the heating wire through a power control element, and a temperature sensing period, in which a temperature sensing current is generated by supplying a pulse signal voltage to the heating wire; and receive a temperature sensing voltage signal by the temperature sensing current flowing in the heat sensing wire through the temperature sensitive insulating resin by the pulse signal voltage in the temperature sensing period, and control a heating temperature of the heating device by controlling the power control element in the heating period according to the received temperature sensing voltage signal.

### TECHNICAL FIELD

The present disclosure relates to a smart heating controller that uses a heat sensing wire utilizing temperature sensitive insulating resin in a DC heating device to enable an accurate temperature detection along a heating wire throughout the heating device.

### BACKGROUND

Electric blankets and electric mats designed for AC-powered electric heating generate heat by use of heating wires. In heating devices, such as electric mats, the temperature of the mat is kept warm by the heat generated by flowing electric currents to the heating wires. When the electric currents flow into the heating wires, heat is generated, elevating the temperature. Without a proper temperature control, the temperature of the heating wires will continue to rise, possibly resulting in a heat damage or fire caused by overheating. Therefore, a precise temperature control by use of a heating controller is required so that the heating unit of the heating device consistently stays in a desired temperature range. The electrical appliances safety control laws in Korea stipulate that the maximum temperature radiated by electrical devices be 95 degrees Celsius.

Techniques studied for controlling the temperature of the heating device include, for example, installing temperature sensors, which are for detecting the temperature of the heating wires, and bimetal sensors, which are means for preventing an excessive elevation of the temperature, at various measurement locations to detect the temperature and control the supplied electric power, and interposing temperature sensitive insulating resin, of which impedance decreases when the temperature rises, between heating wires and heat sensing wires, which are wound in parallel with the heating wires, and detecting, by the temperature sensitive insulating resin, a variance in alternating currents flowing through the heat sensing wires to control the temperature.

Using the temperature sensors and the means for preventing an excessive elevation of the temperature may enable a normal temperature control when the electric mat is used in an unfolded state, but the temperature may not be properly detected, causing a local overheating, when a heavy object is placed over the electric mat or when portions of the electric mat where the temperature senor or bimetal is not installed are folded.

When the electric mat is manufactured, a length of about 25 m is used for an area of about 100 cm by 180 cm in the case of a single-person use, and a length of about 34 m is used for an area of 140 cm by 180 cm in the case of a two-person use. As such, installing the temperature sensors or bimetals evenly at the entire stretch of the elongated sections would be difficult not only in the manufacturing perspective but also in the economic perspective. Accordingly, a typical electric mat has the temperature sensors or bimetals installed at 2 or 3 locations therein. If such an electric mat is overheated due to, for example, folding of the electric mat at portions thereof where the temperature sensors or bimetals are not installed, a precise temperature detection is structurally unattainable.

In the technique involving heat sensing wires, an outside of the heating wires is insulated with nylon resin, of which the impedance changes with temperature, and then the heat sensing wires are wound on the nylon resin before the heat sensing wires are covered with an external insulation material. In the heat sensing wire technique using the temperature sensitive insulating resin, the heating wires and the heat sensing wires are installed in parallel such that it is possible to detect the temperature at every location where the heat sensing wires are installed and to prevent a local overheating. As such, it is more advantageous in terms of workability, cost and safety than the technique using the temperature sensors or bimetals.

In the heat sensing wire technique using the temperature sensitive insulating resin, temperature detecting devices mostly studied for heating devices have used AC power, with which currents may flow in a dielectric, which is an insulating resin, owing to characteristics that the impedance of the insulating dielectric reduces when the temperature rises. However, in the case of heating devices using DC power, there has been no device developed for controlling the heating temperature by the heat sensing wire technique using the temperature sensitive insulating resin. This is mainly because the material used for the temperature sensitive insulating resin is mostly made of nylon, which is a dielectric that allows AC signals to pass but blocks DC signals with its insulation resistance, thereby making the DC signals undetectable.

There have recently been many DC heaters developed, including electric blankets and electric mats, that are highly portable without generating electromagnetic fields. KR Utility Model Publication 20-0296244 introduces a DC automatic thermostat for an electronic mat characterized with triggering a thyrister using a microcontroller after having converted an AC input voltage to a DC voltage.

The presently used DC seat cushions and DC mats have several advantages, including, for example, having a superior stability owing to using a voltage between 5 V and 24 V, which is lower than AC 220 V, generating no electromagnetic field owing to using a DC power rather than an AC power, and being portable owing to being powered by batteries. In some DC mats being developed, a DC voltage of 12 V or 24 V is supplied by use of a AC-DC adapter or a portable battery.

The available DC heating products mainly use temperature sensors and bimetal sensors to control the temperature. However, as described above, the bimetal technique has a number of disadvantages including, for example, not being able to detect locally-occurred overheating at folded portions and having a poor workability and increased manufacturing costs due to sensors required to be installed and connected when heating cables are arranged.

Therefore, there is a demand for a smart heating controller that may enable a precise temperature control at folded portions or locally-overheated areas in heating devices such as electric mats using DC power and heating elements used inside automobiles, provide a better workability, and lower manufacturing costs.

### SUMMARY

The present disclosure provides an economical smart heating controller that may control the temperature precisely and prevent local overheating by use of heat sensing wires using a temperature sensitive insulating resin in a DC heating device.

The present disclosure also provides a heating controller of a DC heating device that may safely protect the heating device from local heating of the DC heating device, failure of heating wires and failure of an electrical element for temperature control and may be economically manufactured.

According to an aspect of the present disclosure, a heating controller of a heating device using DC power is provided. A heating cable of the heating device includes: a heating wire covered with temperature sensitive insulating resin and configured to be heated by the DC power; and a heat sensing wire wound spirally with the covered temperature sensitive insulating resin on an exterior thereof. The heating controller is configured to alternatingly have a heating period, in which the heating wire is heated by supplying the DC power to the heating wire through a power control element, and a temperature sensing period, in which a temperature sensing current is generated by supplying a pulse signal voltage to the heating wire. In the temperature sensing period, a temperature sensing voltage signal by the temperature sensing current flowed in the heat sensing wire through the temperature sensitive insulating resin by the pulse signal voltage is inputted, and the power control element is controlled in the heating period according to the temperature sensing voltage signal to control the heating temperature of the heating device.

Moreover, the heating controller outputs an Off/On output signal to a gate of the power control element at least once in the temperature sensing period to turn the power control element off and on to generate the pulse signal voltage.

Moreover, the heating controller performs the temperature sensing period for 15 to 30 ms every 300 to 1,000 ms.

Moreover, the heating controller includes a temperature sensing signal unit configured to sense a temperature sensing current, in which the pulse signal voltage flows to the heat sensing wire through the temperature sensitive insulating resin, to form a temperature sensing signal voltage; a temperature sensing control voltage conversion unit configured to amplify a signal current inputted from the temperature sensing signal voltage of the temperature sensing signal unit to generate a temperature sensing control voltage; an output control unit including the power control element configured to control a supply of DC power supplied to the heating wire; and a central control unit configured to transfer a control signal for the heating period and the temperature sensing period to the power control element according to a programmed process and receive a temperature sensing control voltage of the temperature sensing control voltage conversion unit to control the power control element of the output control unit to turn on and off.

Moreover, the temperature sensing signal unit is configured to have one side terminal S1 and the other side terminal S2 of the heat sensing wire connected each other at a first sensing node SV1 and to have a first voltage generating condenser connected between the first sensing node SV1 and a first terminal node nd1 connected to the other side terminal of the heating wire, wherein a temperature sensing signal voltage is formed at the first voltage generating condenser according to a heating temperature of the heating wire.

Moreover, the first voltage generating condenser has the capacitance that is about 100 to 1,000 times greater than the capacitance of the temperature sensitive insulating resin.

Moreover, the temperature sensing control voltage conversion unit is connected to a second power source (DC−) through a third distribution resistor R3 serially connected with a second distribution resistor R2 via an input terminal diode D2 from the first sensing node SV1; a connection point with the second distribution resistor R2 and the third distribution resistor R3 is connected with a base of a current-amplifying first transistor TR1; a collector of the current-amplifying first transistor TR1 is connected with a first power source (DC+) of the DC power source through a fourth resistor R4; an emitter of the current-amplifying first transistor TR1 is connected to a ground via a fifth resistor R5 to which a second condenser C2 is connected in parallel; an emitter of the current-amplifying first transistor TR1 is inputted to a temperature sensing voltage terminal of a central control unit; and the central control unit is configured to turn the power control element off if a temperature sensing control voltage inputted to the temperature sensing voltage terminal is determined to be higher than a predetermined temperature voltage.

Moreover, the heating controller further includes an operating power source unit configured to supply a DC operating power to an internal temperature control circuit. The temperature sensing control voltage conversion unit is configured to connect a +5 V terminal of the operating power source unit to a connection point of the emitter of the current-amplifying first transistor TR1 and the second condenser C2 through a third diode D3 for protecting the central control unit. The central control unit is configured to turn the power control element off if a temperature sensing voltage inputted to the temperature sensing voltage terminal is not within a predetermined range of normal input voltage, that is, if the temperature sensing voltage is greater than 4.8 V or smaller than 0.2 V, and then to control the power control element to stop outputting so as not to restart the operation.

Moreover, a one side terminal H1 of the heating wire is connected with a first power source (DC+) of the DC power source, and the other side terminal H2 of the heating wire is connected with a one side terminal of a first power control element FET1 of the output control unit. The other side terminal of a second power control element connected serially with the other side terminal and the one side terminal of the first power control element is connected with a second power source (DC−).

Moreover, gates of the first power control element and the second power control element are connected, respectively, to gate output terminals A, B of the central control unit. A sixth distribution resistor R6 is connected with either terminal of the first power control element, and a seventh distribution resistor R7 is connected with either terminal of the second power control element. A connection point 2 of the sixth distribution resistor R6 and the seventh distribution resistor R7 is connected with an operation signal sensing terminal SV4 of the central control unit, and the connection point 2 is connected to the +5 V terminal of the operating power source unit via a fourth diode D4. Resistance values of the sixth distribution resistor R6 and the seventh distribution resistor R7 are distributed in such a way that a monitor voltage of the connection point 2 is set in a range of 1 to 4 V in a normal temperature sensing period. If a voltage that is greater or smaller than a predetermined range of normal monitor voltage is inputted to the operation signal sensing terminal (SV4) in the temperature sensing period, the central control unit is configured to output an OFF control signal through the gate output terminals (A, B) and then to control the gate output terminals (A, B) of the central control unit to stop outputting so as not to restart.

According to an embodiment of the present disclosure, using a heat sensing wire utilizing a temperature sensitive insulating resin around a heating wire of a DC heating device, it is possible to sense the temperature accurately in the entire section along the heating wire and thus provide a heating controller that may control the temperature precisely and prevent a local overheating.

According to an embodiment of the present disclosure, a separate temperature sensor or bimetal sensor does not need to be installed when manufacturing a DC electric mat or seat cushion, and the DC electric mat or seat cushion may be economically manufactured with a minimum number of parts by a simple process of arranging and sewing up a heating cable, which is a heat sensing wire wound over a heating wire covered with a temperature sensitive insulating resin, on a mat.

The heating controller in accordance with an embodiment of the present disclosure is capable of accurate temperature sensing, owing to receiving a temperature sensing voltage signal by charging/discharging current flowing in the heat sensing wire through the temperature sensitive insulating resin at every sensing period in which a pulse signal is generated while a DC voltage are applied to the heating wire.

The heating controller in accordance with an embodiment of the present disclosure is capable of sensing the temperature throughout the entire section of the heating wire even if a portion of the heating wire is locally overheated, thereby controlling the temperature more precisely and quickly over the heating controllers employing the conventional temperature sensors and bimetals.

The heating controller in accordance with an embodiment of the present disclosure is capable of effectively controlling the heating temperature resulting from DC power with a simple circuit structure and a minimal number of parts, thereby improving the workability, simplifying the manufacturing process and lowering the manufacturing costs.

The heating controller in accordance with an embodiment of the present disclosure is provided with a circuit for detecting any spiral contact caused by a destruction of insulation between the heating wire and the heat sensing wire, thereby effectively and quickly blocking the heating circuit.

Moreover, the heating controller in accordance with an embodiment of the present disclosure supplies DC power to the heating wire by serially connecting 2 power control elements, and thus the heating circuit may be effectively and quickly cut off even if any one of the power control elements fails and cannot be controlled due to heating.

With the heating controller for a heating device in accordance with an embodiment of the present disclosure, it is possible to lower the generation of electromagnetic field owing to the use of DC power, to eliminate the risk of electric shock owing to a lower voltage, and to detect the temperature and prevent a local overheating without the use of a bimetal sensor, which is conventionally used to detect the temperature and prevent an excessive elevation of temperature.

### BRIEF DESCRIPTION OF THE DRAWINGS

FIG. 1 illustrates an exemplary heating controller supplied with a DC power in accordance with an embodiment of the present disclosure.

FIG. 2 illustrates an exemplary structure of a heating cable in accordance with an embodiment of the present disclosure.

FIG. 3 illustrates a temperature sensing signal being generated at a heat sensing wire SW1 when a first voltage generating condenser C1 is not installed in the heating controller.

FIG. 4 illustrates an exemplary waveform of a temperature sensing signal being inputted from the heat sensing wire SW1 when the first voltage generating condenser C1 is installed in a temperature sensing signal unit 17 in accordance with an embodiment of the present disclosure.

FIG. 5 illustrates an exemplary waveform of the temperature sensing signal being inputted from the heat sensing wire SW1 that has a higher temperature than the temperature shown in FIG. 4, when the first voltage generating condenser C1 is installed in the temperature sensing signal unit 17 in accordance with an embodiment of the present disclosure.

HW1: heating wire
SW1: heat sensing wire
TSR: temperature sensitive insulating resin
11: operating power source unit
12: temperature setting unit
13: temperature sensing control voltage conversion unit
14, 15: output control unit
16: display unit
17: temperature sensing signal unit

### DETAILED DESCRIPTION

The terms in the present disclosure are used for describing and illustrating specific embodiments and are not intended to limit the present disclosure. It shall be appreciated that any terms described in singular forms encompass a plurality of said terms, unless otherwise described explicitly.

When it is described to “include” or “comprise” an element in the present disclosure, it shall not mean that another element or other elements are excluded but such element or elements may be further included, unless explicitly described to the contrary.

Terms such as first and second may be used to describe certain elements of an embodiment of the present disclosure, but it shall be appreciated that these terms are used for distinguishing one element from another and do not limit the nature, order or step of said elements. When one element is described to be “connected,” “coupled” or “accessed” to or with another element, said one element may be directly connected, coupled or accessed to or with said another element, but it shall be appreciated that said one element may be connected, coupled or accessed to or with said another element by way of yet another element therebetween.

Hereinafter, a heating controller using a DC power utilizing a heat sensing wire technique and a temperature measurement period technique in accordance with the present disclosure will be described in detail.

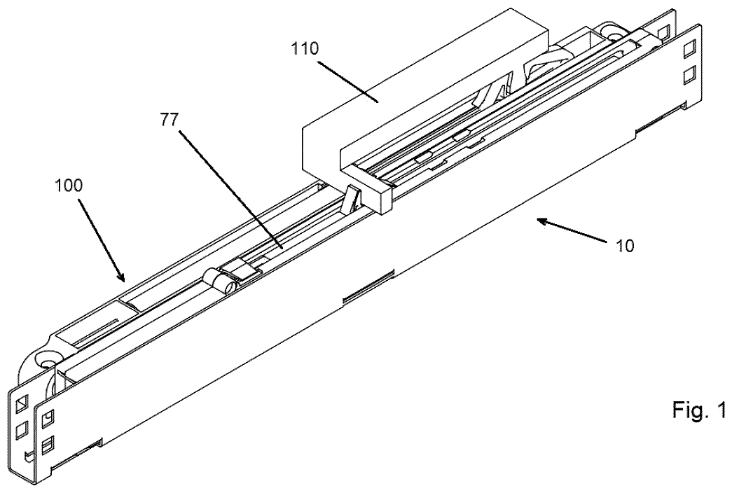

FIG. 1 illustrates an exemplary heating controller supplied with a DC power in accordance with an embodiment of the present disclosure.

Referring to FIG. 1, a heating cable of a heating device in accordance with an embodiment of the present disclosure is insulated by having a temperature sensitive insulating resin TSR filled in between an exterior of a heating cable HW1 and a heat sensing wire SW1.

In the present disclosure, the temperature sensitive insulating resin TSR refers to an insulator resin in which impedance decreases when temperature rises and increases when temperature drops. For example, in an embodiment of the present disclosure, a nylon resin may be used as the temperature sensitive insulating resin TSR. Nylon resin is a dielectric known to increase the impedance at a low temperature and decrease the impedance as the temperature rises. Nylon resin has the properties of an insulator; that is, although direct currents cannot flow through, the nylon resin works as a condenser in which charging/discharging sensing currents may flow.

The heating cable in accordance with an embodiment of the present invention includes: a heating wire covered with a temperature sensitive insulating resin and configured to be heated by DC power; and a heat sensing wire wound spirally with the covered temperature sensitive insulating resin on an exterior thereof. For example, the heating cable in accordance with an embodiment of the present invention is structured with the heating wire HW1 formed in the middle thereof and is arranged in the sufficient vicinity of the heat sensing wire to be insulated from the heat sensing wire SW1, and the heating wire HW1 and the heat sensing wire SW1 are insulated from each other by having the temperature sensitive insulating resin TSR filled between the heating wire HW1 and the heat sensing wire SW1. According to an embodiment of the present disclosure, the heat sensing wire SW1 is used as a temperature sensing wire for measuring the temperature of the temperature sensitive insulating resin TSR.

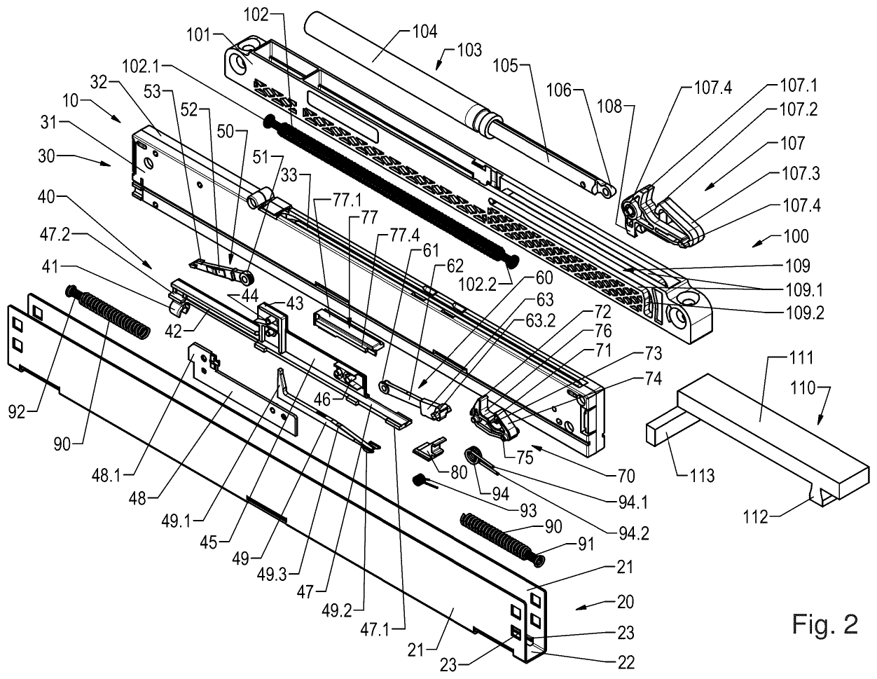

FIG. 2 illustrates an exemplary structure of the heating cable in accordance with an embodiment of the present disclosure. Referring to FIG. 2, the heat sensing wire type of heating cable in accordance with an embodiment of the present disclosure has the heating cable HW1 positioned in the core thereof and has nylon resin covered on an exterior of the heating wire HW1, the nylon resin being the temperature sensitive insulating resin TSR that varies the impedance with the temperature. Then, the heat sensing wire SW1 is wound on an exterior of the nylon resin, and then the nylon resin is covered with PVC, which is an exterior insulating material.

Unlike alternating currents, direct currents flowed in the heating wire HW1 is blocked by the temperature sensitive insulating resin, which is an insulator for direct currents, and temperature sensing currents do not flow in the heat sensing wire SW1. However, by supplying a pulse signal voltage, which varies over time, to the heating wire HW1, pulse signal currents generated by the pulse signal voltage supplied to the heating wire HW1 may be transferred through the temperature sensitive insulating resin TSR to the heat sensing wire SW1 and eventually grounded.

Since the impedance of the temperature sensitive insulating resin is changed by temperature, the pulse signal currents transferred to the heat sensing wire SW1 through the temperature sensitive insulating resin TSR vary according to the temperature of the temperature sensitive insulating resin TSR. For instance, when the temperature of the temperature sensitive insulating resin TSR increases, the currents generated by the pulse signal voltage increase, and when the temperature of the temperature sensitive insulating resin TSR decreases, the currents generated by the pulse signal voltage decrease.

By utilizing the property of the currents transferred through the temperature sensitive insulating resin that changes by the variation of temperature, the heating controller in accordance with an embodiment of the present disclosure is configured to sense the temperature in a temperature sensing period to control the current flowing in the heating wire HW1 and control the heating temperature of the heating wire HW1.

For example, the heating controller in accordance with an embodiment of the present disclosure is configured to have a heating period, in which the heating wire HW1 is heated by DC power supplied to the heating wire HW1 through a power control element, and a temperature sensing period, in which temperature sensing currents are generated by supplying a pulse signal voltage to the heating wire HW1. In the temperature sensing period, a central control unit 20 is inputted with a temperature sensing voltage signal generated by the pulse signal voltage and converted by a sensing current flowing in the heat sensing wire through the temperature sensitive insulating resin from the heating wire HW1, and the heating temperature of the heating device is controlled by controlling the power control element in the heating period according to the temperature sensitive voltage signal.

In an embodiment of the present disclosure, the pulse signal voltage is generated by turning off and on the power control element supplying the DC power to the heating wire HW1 during the temperature sensing period (e.g., 20 ms in an embodiment). In another embodiment of the present disclosure, the pulse signal voltage may be supplied to the heating wire by a separate pulse generator during the temperature sensing period.

Referring to FIG. 1, the heating controller in accordance with an embodiment of the present disclosure is configured with a circuit in such a way that one side terminal H1 of the heating wire HW1 is connected with a first power source (DC+) of the DC power source and the other side terminal H2 of the heating wire HW1 is connected with a first terminal node nd1, to which a one side terminal of the power control elements FET1, FET2 is connected, to be grounded through the second power control element FET2, which is serially connected with the first power control element FET1. Moreover, a second power source (DC−) is grounded.

Moreover, a one side terminal S1 and the other side terminal S2 of the heat sensing wire SW1 are both connected to a first sensing node SV1, and a first voltage generating condenser C1 is connected between the first sensing node SV1 and the first terminal node nd1 connected with the other side terminal H2 of the heating wire HW1.

According to an embodiment of the present disclosure, the first voltage generating condenser C1 is charged with the temperature sensing signal voltage through the heat sensing wire SW1 according to the heating temperature of the heating wire HW1.

Moreover, the heating controller is configured to generate the pulse signal voltage by turning the power control element off and on by outputting an OFF/ON output signal once or more to the gate of the power control element in the temperature sensing period.

The heating controller in accordance with an embodiment of the present disclosure is configured to use a variation of the sensing currents to turn the power control elements off and on by heating the heating wire HW1 during the heating period, in which the currents generated by the supply of DC voltage of the DC power flows through the heating wire HW1 and the power control elements FET1, FET 2, and allowing the sensing currents generated by the pulse signal voltage to flow to the heat sensing wire SW1 through the temperature sensitive insulating resin TSR in the temperature sensing period.

The heating controller in accordance with an embodiment of the present disclosure includes: an operating power source unit 11 configured to supply a DC operating power to the heating wire HW1 and an internal temperature control circuit; a temperature sensing signal unit 17 configured to sense a temperature sensing current, in which the pulse signal voltage flows to the heat sensing wire SW1 through the temperature sensitive insulating resin TSR, to form a temperature sensing signal voltage; a temperature sensing control voltage conversion unit 13 configured to amplify a signal current inputted from the temperature sensing signal voltage of the temperature sensing signal unit 17 to convert to a temperature sensing control voltage; an output control unit 14, 15 including the power control element configured to control a supply of DC power supplied to the heating wire HW1; a central control unit 20 configured to transfer a control signal for the heating period and the temperature sensing period to the power control elements of the output control unit according to a programmed process and receive a temperature sensing control voltage of the temperature sensing control voltage conversion unit 13 to control the output control unit to turn on and off and to control each of the above units; and a temperature setting unit 12 configured to receive an input from a user for setting an operating temperature.

Referring to FIG. 1, the DC power of the DC heating device in accordance with an embodiment of the present disclosure is illustrated to supply DC 24 V. It shall be appreciated however that the supplied DC voltage is for illustrative purposes only and that any other voltages, such as 12 V, 5 V, etc., may be used with the same technical advantage.

Referring to FIG. 1, in the temperature sensing signal unit 17, the one side terminal S1 and the other side terminal S2 of the heat sensing wire SW1 are connected to the first sensing node SV1, and the first voltage generating condenser C1 is connected between the first sensing node SV1 and the first terminal node nd1 connected with the other side terminal H2 of the heating wire HW1. The temperature sensing signal voltage is formed at the first voltage generating condenser C1 by the currents flowing to the heat sensing wire SW1 according to the heating temperature of the heating wire. Moreover, the first terminal node nd1 is connected with the other side terminal of the first power control element FET1.

The temperature sensing control voltage conversion unit 13 is connected to the ground through a third distribution resistor R3 connected serially with a second distribution resistor R2 by way of an input terminal diode D2 from the first sensing node SV1. A second sensing node is formed at a connection point of the second distribution resistor R2 and the third distribution resistor R3 and is connected with a base of a current-amplifying first transistor TR1. A collector of the current-amplifying first transistor TR1 is connected with the first power source (DC+) of the DC power source through a fourth resistor R4, and an emitter of the current-amplifying first transistor TR1 is connected to the ground via a fifth resistor R5 to which a second condenser C2 is connected in parallel. Moreover, the emitter of the first transistor TR1 is connected with a temperature sensing voltage terminal, which is a third sensing node SV3 at an output terminal of the temperature sensing control voltage conversion unit 13, to be connected with an input terminal of the central control unit 20.

According to an embodiment of the present disclosure, the current of the temperature sensing signal voltage being inputted through the input terminal diode D2 is very weak and thus is amplified by connecting the NPN-type current-amplifying first transistor TR1 in an emitter flower technique. In the temperature sensing control voltage conversion unit 13, the amplified current flows, in the order of, from the first power source (DC+) to the fourth resistor R4, the collector of the current-amplifying first transistor TR1, the emitter, the fifth resistor R5 and finally to the ground.

The current flowing in both ends of the fifth resistor R5 is charged in the second condenser C2 to form the temperature sensing control voltage, which is inputted to the central control unit 20 via the temperature sensing voltage terminal, which is the third sensing node SV3.

Moreover, the temperature sensing control voltage conversion unit 13 further includes a first central control unit protection circuit. The first central control unit protection circuit connects a connection point of the emitter of the current-amplifying first transistor TR1 and the second condenser C2 to the +5 V terminal of the operating power source unit through a third diode D3 for protecting the central control unit. The voltage inputted to the central control unit 20 by the first central control unit protection circuit will not exceed +5 V. The first central control unit protection circuit is configured to prevent high 24 V or any voltage exceeding +5 V from being inputted to the central control unit 20 due to, for example, a spiral contact between the heating wire HW1 and the heat sensing wire SW1 caused by damaged insulation of the temperature sensitive insulating resin from, for example, overheating.

While the temperature sensing control voltage conversion unit 13 has employed the emitter flower technique of the first transistor TR1 to amplify the signal current inputted from the temperature sensing signal voltage in an embodiment of the present disclosure, it shall be appreciated that the NPN-type first transistor TR1 may be substituted with any equivalent means, for example, an OP AMP, for amplifying the input voltage signal in other embodiments.

Referring to FIG. 1, when currents from DC power flow to the heating wire HW1, the voltages in the heating wire HW1 are distributed in such a way that the input voltage of 24 V is observed at a point H1 of the heating wire and zero volt, which is the same as the ground potential, is observed at a point H2 of the heating wire.

In the heating controller in accordance with an embodiment of the present disclosure, the central control unit may be implemented with a microcomputer in which the central control unit is embedded in a single chip. In a predetermined temperature sensing period of the microcomputer in accordance with an embodiment of the present disclosure, the first power control element FET1 and the second power control element FET2 are turned on and off and on again for 20 ms to generate the pulse signal voltages of 24 V, 0 V and 24 V at the first terminal node nd1 connected to the H2 terminal, which is the other side terminal of the heating wire HW1. Owing to the property of being varied over time in the temperature sensing period, the pulse signal voltages of 24 V, 0 V and 24 V will cause the currents to be charged and discharged between the heating wire HW1 and the heat sensing wire SW1 through the temperature sensitive insulating resin to result in a temperature sensing signal at a point of the first sensing node SV1. Here, as the applied voltage of 24 V is significantly smaller that the AC voltage of 220 V, the discharged currents will result in the temperature sensing currents to flow in the form of a sawtooth wave due to the very weak pulse signal voltages and thus may not be clearly distinguished with temperature variations.

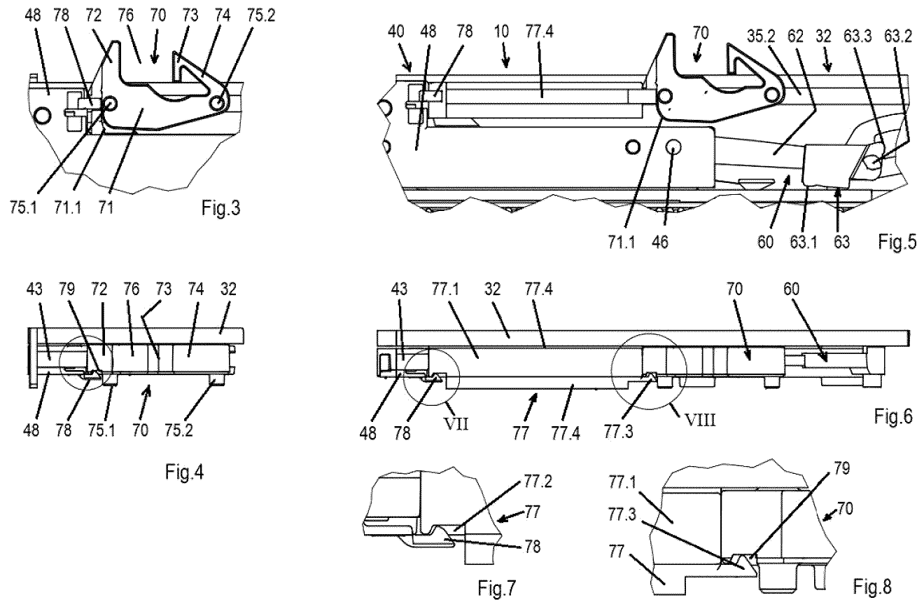

FIG. 3 illustrates the temperature sensing signal being generated in the heat sensing wire SW1 at the first sensing node SV1 without having the first voltage generating condenser C1 installed in the temperature sensing signal unit 17. Referring to FIG. 3, the temperature sensing signal being outputted to the one side terminal S1 of the heat sensing wire SW1 when the temperature sensitive insulating resin interposed between the heating wire HW1 and the heat sensing wire SW1 has a large impedance flows to a slope of the sawtooth wave form. Accordingly, while it is possible to measure the current based on the temperature variation, the difference based the temperature variation is not clearly distinguishable.

In an embodiment of the present disclosure, the first voltage generating condenser C1 is connected between the first sensing node SV1 and the first terminal node nd1, which is connected to the other side terminal H2 of the heating wire HW1, in order to convert the weak sawtooth wave signal to a more clearly distinguishable square wave.

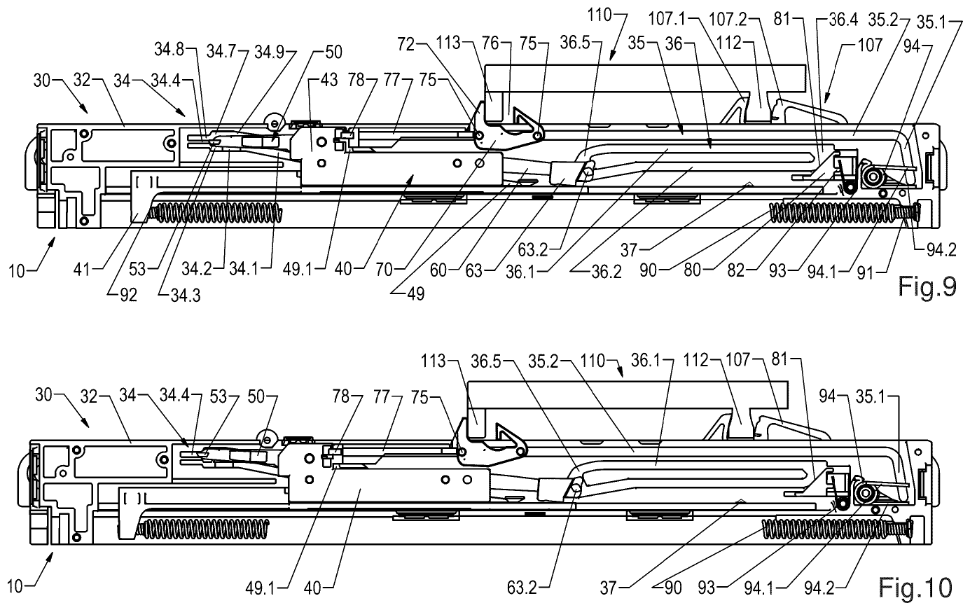

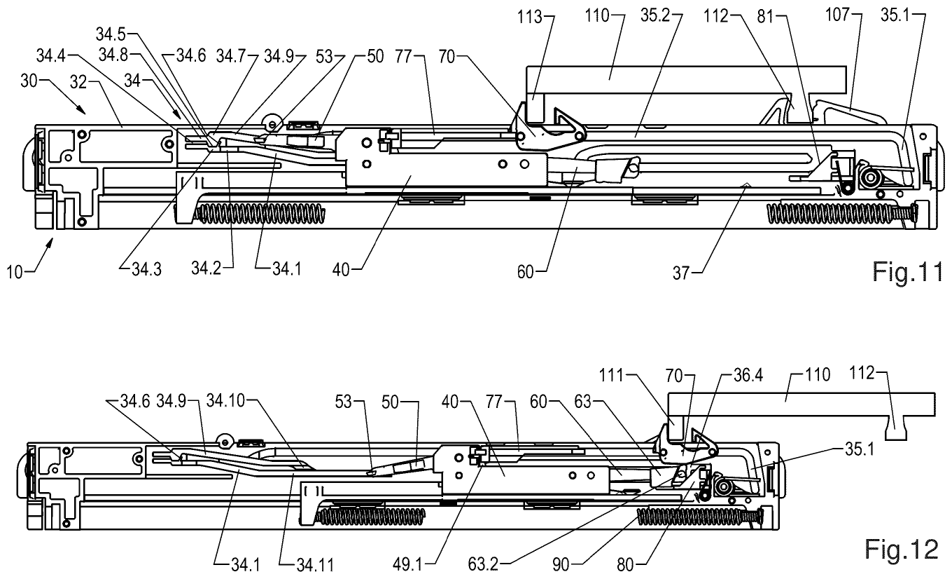

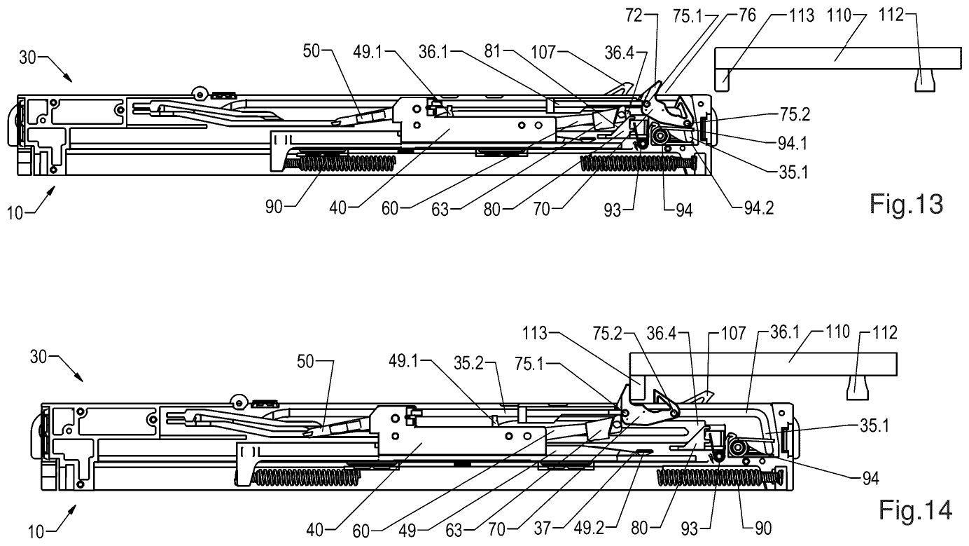

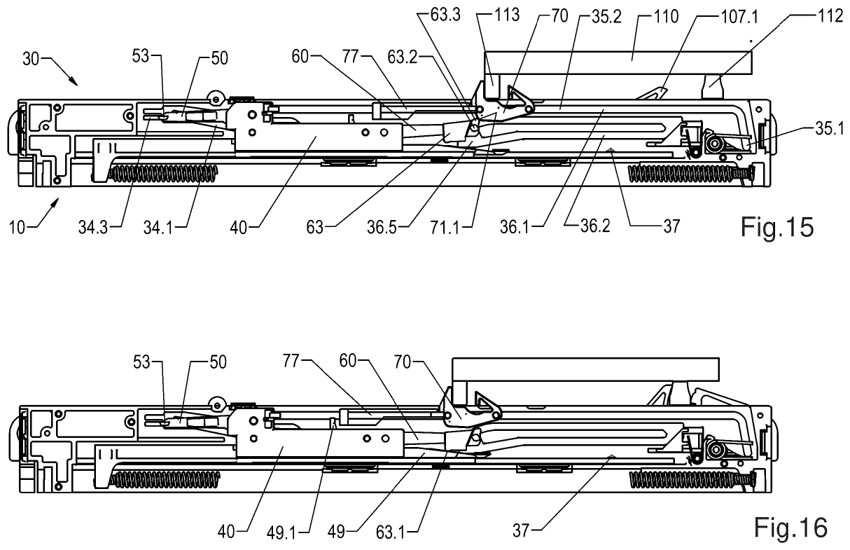

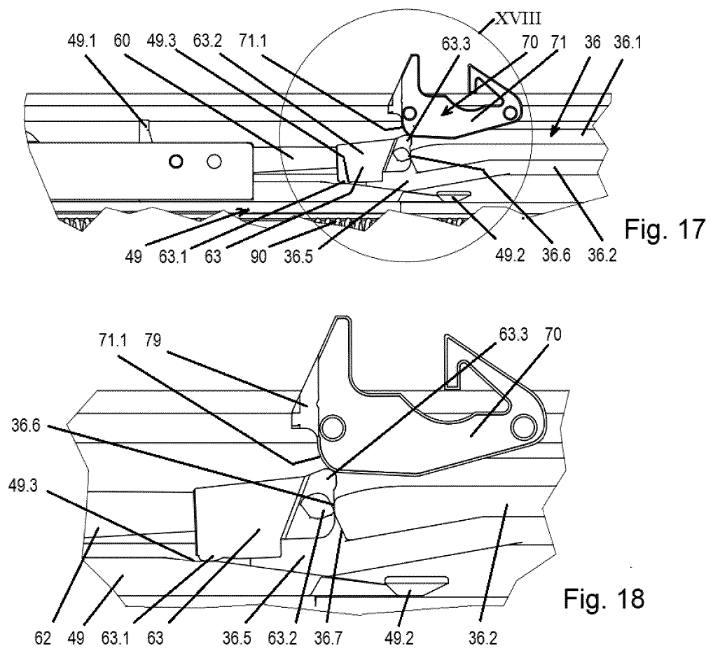

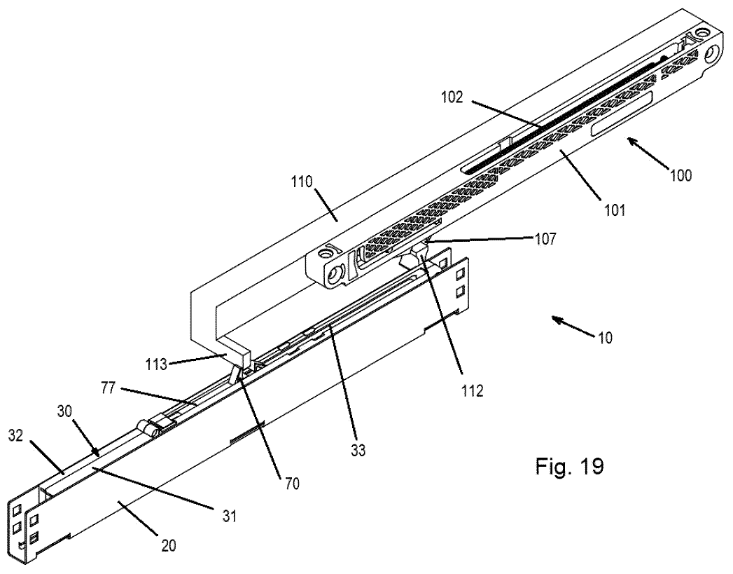

FIG. 4 illustrates an exemplary waveform of the temperature sensing signal being inputted from the heat sensing wire SW1 when the first voltage generating condenser C1 is installed in the temperature sensing signal unit 17 in accordance with an embodiment of the present disclosure, and FIG. 5 illustrates an exemplary waveform of the temperature sensing signal being inputted from the heat sensing wire SW1 that has a higher temperature than the temperature shown in FIG. 4 when the first voltage generating condenser C1 is installed in the temperature sensing signal unit 17 in accordance with an embodiment of the present disclosure. In FIGS. 4 and 5, the temperature sensing period is set to be turned on at every 400 ms and turned off and on for 20 ms.

FIG. 4 shows voltage waveforms of the first sensing node and the second sensing node when the temperature of the heating wire is lower than a normal state. As shown in FIG. 4, by connecting the first voltage generating condenser C1 between the first sensing node SV1 and the first terminal node nd1, the temperature sensing signal voltage may appear clearly in square waveforms for the first sensing node SV1 and the second sensing node SV2.

In an embodiment of the present disclosure, the length of the heating wire HW1 was 25 m, and the capacitance of the temperature sensitive insulating resin was measured to be 3 nF at 20° C. According to an embodiment of the present disclosure, when the temperature of the heating wire HW1 rises so that the temperature of the temperature sensitive insulating resin becomes 90° C., the capacitance of the temperature sensitive insulating resin increases to nF from 3 nF. This is due to the property of the temperature sensitive insulating resin TSR in which the impedance decreases when the temperature rises.

By using the AC input power of 220 V, the temperature may be directly controlled by utilizing the variation of the condenser capacity according to the temperature. However, in the case where the DC power of 24 V is used, the temperature sensing signal current is too weak to be used for controlling the temperature.

The capacitive reactance may be computed using Xc=1/(2πfC). While the determining frequency is 60 Hz of sine wave alternating currents in commercial AC power, the pulse signal voltage used in the temperature sensing period in accordance with an embodiment of the present disclosure is a square wave at the frequency of at least about 2 Hz.

Accordingly, since no current is flowed by the DC power while the temperature sensing pulse signal is generated, the power consumption of the heating wire HW1 becomes smaller. This means that the more the pulse signals (i.e., frequency increases) in the temperature sensing period, the less the power consumed for heating the heating wire HW1.

In the impedance characteristics of the temperature sensitive insulating resin TSF in accordance with an embodiment of the present disclosure, the impedance becomes relatively larger even if the temperature and capacitance of the heating wire remain the same, compared to when the AC power is supplied, since the frequency is lower than the AC power.

Moreover, since DC 24 V is used rather than AC 220 V, the temperature sensing signal current flowing through the temperature sensitive insulating resin TSR has a lower voltage than the AC power even if the capacitance is the same, and thus a much smaller amount of currents pass the capacitor than when AC voltage is used.

In an embodiment of the present disclosure, in order to address this shortcoming, the first voltage generating condenser C1 is connected between the first sensing node SV1, to which the one side terminal S1 and the other side terminal S2 of the heat sensing wire is connected, and the first terminal node nd1 to allow a pulse voltage waveform having the temperature signal currents accumulated at the first sensing node SV1 to clearly appear.

Upon analyzing various tests, the capacitance of the first voltage generating condenser C1 is preferably between 0.3 nF and 3 nF, which is about 100 to 1,000 times the capacitance of the temperature sensitive insulating resin at room temperature. Moreover, the preferable optical capacitance is analyzed to be 1 uF in a preferable embodiment of the present disclosure.

In the case of FIG. 3, where the first voltage generating condenser C1 is not installed, the capacitance between the heating wire HW1 and the heat sensing wire SW1 is 3 nF, which is significantly large, resulting in a poor appearance of the temperature sensing signal voltage waveform.

FIG. 4 shows an initial waveform while the first voltage generating condenser C1 having the capacitance of 1 uF is installed. In FIG. 4, the first sensing node SV1 is measured using a 100:1 probe, and the second sensing node SV2 is measured using a 1:1 probe.

While the temperature of the temperature sensitive insulating resin TSR caused by the initial heating of the heating wire HW1 is low, it is seen in the square pulse waveform of the first sensing node SV1 that the voltage is 20 V in the heating period and +4 V in the temperature sensing period, in which no heating currents flow.

At the second sensing node SV2, the voltage waveform at either end of the third distribution resistor R3 is shown by the sensing currents flowing in the order of an input end diode D1, the second distribution resistor R2, the third distribution resistor R3 and the ground. At the second sensing node SV2, a waveform of 3 V, which is slightly lower than the waveform of the first sensing node SV1, is shown in the temperature sensing period.

FIG. 5 shows the waveforms of the first and second sensing nodes when the temperature of the heating wire rises normally. Once the temperature of the temperature sensitive insulating resin TSR is elevated by the heating of the heating wire HW1, the capacitance of the temperature sensitive insulating resin TSR is increased. That is, as described earlier, the capacitance of the temperature sensitive insulating resin TSR is increased from 3 nF to 10 nF when the temperature of the temperature sensitive insulating resin TSR is increased to 90° C. When the temperature of the temperature sensitive insulating resin TSR is increased to 90° C., the waveform of the first sensing node SV1 is shown to be −10 V in the heating period and about +15 or higher in the temperature sensing period. Moreover, it can be seen that the pulse waveform of 15 V appears at the second sensing node SV2 in the temperature sensing period.

That is, according to an embodiment of the present disclosure, it can be seen that a mere action of briefly turning the power control elements off and on in the temperature sensing period will generate the pulse signal voltage to generate the temperature sensing signal voltage at the first sensing node SV1 and the second sensing node SV2 following a temperature variation.

Meanwhile, as the temperature rises, the temperature sensing signal voltage waveform is generated, but the current is too weak to be analyzed by the central control unit. In an embodiment of the present disclosure, the heating controller further includes the temperature sensing control voltage conversion unit 13 configured to convert the temperature sensing signal voltage from a range of 0 to 5 V to a more clearly distinguishable temperature sensing control voltage in order to complement the above shortcoming and enhance the accuracy of analysis by the central control unit for the temperature sensing control voltage pursuant to the temperature change. The temperature sensing control voltage conversion unit 13 of the present disclosure is characterized by using the emitter flower technique of an NPN-type transistor to amplify and convert the signal current.

In the temperature sensing control voltage conversion unit 13 in accordance with an embodiment of the present disclosure, the sensing signal voltage inputted from the temperature sensing signal unit 17 is inputted to a base of the current-amplifying first transistor TR1 and amplified, and then the signal outputted to the emitter is converted to be used as the temperature sensing control voltage signal.

In an embodiment of the present disclosure, the temperature sensing control voltage signal outputted from the temperature sensing control voltage conversion unit 13 is inputted to the microcomputer, which is the central control unit 20, in which the inputted temperature sensing control voltage signal is compared to a predetermined threshold, wherein the temperature sensing control voltage signal is not within the threshold, a control signal is sent to a gate of the power control elements FET1, FET2 to control the supply of power of the heating wire HW1 to eventually control the heating temperature.

According to an embodiment of the present disclosure, a microcomputer chip, in which the central control unit is included in a single chip and a computing device, a memory device, an input/output device, etc. are added to a microprocess by large scale integration (LSI), is used as the central control unit 20.

According to an embodiment of the present invention, the operating power source unit 11 is configured to supply DC 5 V to each of the components as a control voltage. The operating power source unit 11 includes a power switch configured to turn the operating power on and off. Once the power is turned on, the power is supplied to the central control unit 20. Once the power is turned off, the power is cut off from the central control unit 20, and the first and second power control elements FET1, FET2 are turned off to stop the power from being supplied to the heating wire HW1.

The temperature setting unit 12 in accordance with an embodiment of the present disclosure may select a desired temperature by having a resistance value of a variable resistor VR1 added or subtracted by a user. The central control unit 20 compares the voltage corresponding to the temperature selected by the temperature setting unit 12 with the temperature sensing control voltage signal inputted by the temperature sensing control voltage conversion unit 13 and maintains the output to an ON signal if the temperature sensing control voltage signal is lower than the voltage corresponding to the selected temperature. Moreover, the central control unit 20 is programmed to output an OFF signal for A and B outputs if the inputted temperature sensing control voltage signal is higher than the voltage corresponding to the selected temperature.

Moreover, the central control unit 20 generates a temperature measuring pulse signal configured to periodically output OFF-ON signals to A and B output terminals during the temperature sensing period. The temperature measuring pulse signal according to an embodiment of the present disclosure is configured to output LOW/HIGH signals one or more times to gates of the first and second power control elements FET1, FET2 during a predetermined time in the temperature sensing period. According to an embodiment of the present disclosures, the central control unit 20 controls the first and second power control elements FET1, FET2 to perform ON, TURN OFF and TURN ON operations for 20 ms, which is the time predetermined by the temperature measuring pulse signal, by the temperature measuring pulse signal to allow a pulse voltage to be instantaneously applied to the heating wire HW1.

As described above, the central control unit 20 maintains the ON signal in the preset heating period and outputs the OFF-ON output signals through A, B terminals for the predetermined time in the temperature sensing period to turn the power control elements FET1, FET2 on and off. Moreover, by supplying the pulse signal voltage periodically turned off and on in every temperature sensing period to the heating wire HW1, the central control unit 20 controls the power control elements FET1, FET2 by receiving the temperature sensing signal generated by the temperature sensing current flowing through the temperature sensitive insulating resin TSR as the temperature sensing control voltage.

According to an embodiment of the present disclosure, the central control unit 20 is configured to alternatingly generate the heating period, in which the heating wire HW1 is heated by having the DC power supplied to the heating wire HW1 through the power control elements, and the temperature sensing period, in which the temperature sensing current is generated by having the pulse signal voltage supplied to the heating wire HW1. In an embodiment of the present disclosure, the temperature sensing period lasts for 15 to 30 ms at every 300 to 1,000 ms. That is, the power control elements FET1, FET2 are kept turned on for 300 to 1,000 ms to supply the DC power to the heating wire HW1, and then the temperature measuring pulse signal voltage is supplied to the heating wire HW1 by turning the power control elements FET1, FET2 off and on for 15 to 30 ms.

Through various experiments, it has been analyzed that, for a DC heating device manufactured with about 25 m of heating wire, sensing the temperature for 20 ms at every 400 ms was most preferable for a precise temperature control and for an efficient energy consumption. For instance, in a preferable embodiment, the A and B output terminals of the central control unit 20 are controlled to maintain an ON signal (high) for 400 ms, output an OFF-ON signal (low-high) for the next 20 ms, and then maintain the ON signal (high) for another 400 ms in an alternating fashion. In other words, the heating current flows for 400 ms and does not flow for the subsequent 20 ms.

In a preferable embodiment, the temperature measuring pulse signal is generated twice a second for 20 ms, and thus the temperature sensing is performed very quickly in real time. In a preferable embodiment based on various experiments, the ratio between the heating period and the temperature sensing period is set to be 20:1. This ratio may be varied to, for example, 30:1, 40:1 or 50:1, depending on the purpose of the heating device. The higher this ratio is, the current flowing in the heating wire HW1 may be more efficient, but the temperature sensing efficiency may be deteriorated due to the less frequent temperature sensing. Therefore, this ratio may be variably applied depending on the type and thickness of the temperature sensitive insulating resin and the length of the heating wire.

In another embodiment of the present disclosure, the heating controller may further include a fuse unit F1 between the first power source (DC+) and the one side terminal H1 of the heating wire HW1, the fuse unit F1 being configured to cut off the circuit if a current in excess of a predetermined current flows.

Hereinafter, the operating state of the heating controller is described with reference to FIG. 1.

Once the power switch is turned on, the current will flow from and in the order of the first power source (DC+), the fuse unit F1, the one side terminal H1, the heating wire HW1, the other side terminal H2, the first power control element FET1, the second power control element FET2 and the ground.

When the DC current flows, the temperature of the temperature sensitive insulating resin will be elevated by the heating from the heating wire, and the impedance of the temperature sensitive insulating resin will be decreased.

When the temperature of the temperature sensitive insulating resin is elevated by the heating wire, the temperature sensing control voltage is elevated and inputted to the third sensing node SV3, to which the output of the temperature sensing control voltage conversion unit 13 is connected. If it is determined by the central control unit 20 that the temperature sensing control voltage is higher than the temperature voltage set by the temperature setting unit 12, the central control unit 20 switches the output signal from high to low through the output terminals A and B to turn the first and second power control elements FET1, FET2.

Once the output signal of the output terminals A and B of the central control unit 20 becomes low, the first and second power control elements FET1, FET2 are turned off, and no heating current will blow. Subsequently, the temperature of the heating device will drop. When the temperature of the heating device is lowered, the impedance of the temperature sensitive insulating resin will be increased again, and the temperature sensing signal voltage of the second sensing node SV2 inputted to the temperature sensing control voltage conversion unit 13 will be decreased. Subsequently, the temperature sensing control voltage, which is the output voltage of the temperature sensing control voltage conversion unit 13, will be decreased.

Once the temperature sensing control voltage signal inputted by the third sensing node SV3 is lowered below a voltage set by the temperature setting unit 12 by the steps programmed in the central control unit 20, the central control unit 20 will switch the output signal from low to high through the output terminals A and B to turn the first and second power control elements FET1, FET2 back on. By repeating this process, the heating temperature of the heating wire HW1 may be maintained consistently within a predetermined temperature range.

In the heating controller in accordance with an embodiment of the present invention, the circuit is configured to allow the inputted temperature sensing control voltage signal to be outside of a predetermined range of normal input voltage while the operating power is turned on if, for example, the insulation of the temperature sensitive insulating resin is ruptured, the power control elements are not working properly, or the heating controller has an internal failure.

Moreover, in accordance with an embodiment of the present disclosure, if the temperature sensing control voltage signal is determined to be outside of the predetermined range of normal input voltage while the operating power is turned on, the central control unit 20 is programmed to turn the first and second power control elements FET1, FET2 off. Moreover, in such a case, the central control unit 20 is controlled to stop the A and B outputs so as to keep the heating controller from restarting. Moreover, the heating controller may further include a means for flickering an LED of a display unit 16 in the form of a warning to allow the user to recognize the warning.

In an embodiment of the present disclosure, the predetermined range of normal input voltage is set to be between 0.2 V and 4.8 V in the central control unit 20. That is, the temperature sensing voltage being inputted to the third sensing node SV3 while the power switch is turned on is determined to be in excess of 4.8 V or below 0.2 V, the power control elements FET1, FET2 are controlled to be turned off, and then the central control unit 20 are controlled to stop outputting the A and B outputs so as to keep the heating controller from restarting. At the same time, the central control unit 20 is programmed to flicker the LED of the display unit 16 in the form of a warning.

Of the heating devices, the electric mats may have heavy objects placed thereon or may be partially folded during the use. In such a case, the area having the heavy object thereon or being folded may be locally overheated. When the local overheating occurs, the portion of the heating wire where the local overheating occurs will have the highest temperature, and it may result in a fire if the overheating persists.

In the case of the electric mat in accordance with an embodiment of the present disclosure, the entire section of nylon resin impedance interposed between the heating wire and the heat sensing wire is provided in a parallel configuration, and thus the local overheating at any one portion will elevate the temperature of the temperature sensitive insulating resin at the very portion. If the temperature of the portion with the local overheating rises over a predetermined threshold, the temperature sensing control voltage of the third temperature sensing node SV3 by the temperature sensing signal voltage of the first temperature sensing node SV1 will rise over a predetermined voltage range. Therefore, the central control unit 20 may sense the temperature sensing signal voltage caused by such a rise of local temperature and cut off the supply of DC power by switching the output signal from high to low through the output terminals A and B and turning the first and second power control elements FET1, FET2 off.

Moreover, the electric mat may experience a rupture in the insulation of the temperature sensitive insulating resin due to overheating or environmental factors, resulting in a short-circuit between the heating wire and the heat sensing wire. In such a case, referring to FIG. 1, the current will flow from and in the order of the first power source (DC+), F1, H1, the heating wire HW1, the short-circuited section, the heat sensing wire SW1, S1, S2, D2, R2, R3 and the ground. At the second sensing node SV2, the DC 24 V is distributed to the second and third distribution resistors to apply the temperature sensing signal voltage of 10 V or higher. Accordingly, a large amount of currents will flow toward the emitter of TR1 of the temperature sensing control voltage conversion unit 13, and the voltage at either end of the second condenser C2 will exceed 5 V.

In an embodiment of the present disclosure, the voltage exceeding 5 V at the third sensing node SV3 connected to the second condenser C2 is allowed to flow to the operating power source unit 11 by the third diode D3 for protecting the central control unit to limit the maximum input voltage to 5 V. Accordingly, the heating controller in accordance with an embodiment of the present disclosure inputs 5 V of temperature sensing control voltage signal to the third sensing node SV3, which is the input terminal of the central control unit 20, if the heating wire HW1 and the heat sensing wire SW1 are short-circuited. When 5 V is inputted to the third sensing node SV3, the central control unit 20 will determine that the inputted temperature sensing control voltage signal has exceeded the predetermined range of normal input voltage (i.e., 0.2 to 4.8 V) and control the first and second power control elements FET1, FET2 to be turned off. Then, by controlling the central control unit 20 to stop outputting A and B outputs to keep the heating device from restarting, the heating device may be safely controlled not to lead to an accident if the heating wire HW1 and the heat sensing wire SW1 are short-circuited.

Moreover, the failure of the electric mat may include an uncontrollable switching due to a failure of switching element caused by an extended use. Such an uncontrollable switching may lead to an accident caused by overheating if the switching element remains turned on despite the low signal sent to the gate because of the overheating. To prevent this kind of failure, the heating controller in accordance with an embodiment of the present disclosure configures the output control units 14, 15 by serially connecting two power control elements, and the central control unit 20 is configured to simultaneously send a same control signal to the gates of the two power control elements through the output terminals A and B.

For example, in an embodiment of the present disclosure, the one side terminal H1 of the heating wire HW1 is connected to the first power source (DC+) of the DC power source, and the other side terminal H2 of the heating wire HW1 is connected with the one side terminal of the first power control element FET1, and the other side terminal of the second power control element FET2 serially connected by having the other side terminal and the one side terminal of the first power control element FET1 connected is connected with the second power source (DC−) of the DC power source. While the gates 1 and 2 of the first power control element FET1 and the second power control element FET2 are connected, respectively, to the first and second gate output terminals A and B of the central control unit 20, the central control unit 20 always sends a same control signal to the first and second gate output terminals A and B.

Moreover, a sixth distribution resistor R6 is connected with either terminal of the first power control element FET1, and a seventh distribution resistor R7 is connected with either terminal of the second power control element FET2, and a connection point between the sixth distribution resistor R6 and the seventh distribution resistor R7 is connected with an operation monitoring signal terminal SV4 of the central control unit 20. Moreover, the connection point is connected to the +5 V side of the operating power source unit via a fourth diode D4 for protecting a second central control unit. In an embodiment of the present disclosure, the voltage exceeding 5 V at the operation signal sensing node SV4 connected to the connection point by a second central control unit protection circuit including the fourth diode D4 is allowed to flow to the operating power source unit 11 by the fourth diode D4 for protecting the central control unit to limit the maximum to 5 V.

Moreover, the heating controller in accordance with an embodiment of the present disclosure distributes the resistance values of the sixth distribution resistor R6 and the seventh distribution resistor R7 with a range of 23-21:1-3 such that a monitor voltage of the connection point of the sixth distribution resistor R6 and the seventh distribution resistor R7 is set in a range of 1 to 4 V in the temperature sensing period. In such a case, if a voltage that is greater or smaller than a normal range of monitor voltage set to the operation signal sensing terminal SV4 is inputted, the central control unit 20 outputs an OFF control signal (a low signal) to the first and second gate output terminals A, B and then controls the A and B outputs of the central control unit 20 to stop outputting so as not to restart the operation. At the same time, the central control unit 20 flickers the LED of the display unit 16 in the form of a warning.

In a preferred embodiment of the present disclosure, the resistance values of the sixth distribution resistor R6 and the seventh distribution resistor R7 are distributed with a range of 21.5:2.5 such that the monitor voltage has a voltage value of 2.5 V in the temperature sensing period. In such a case, if a voltage that is greater than 3 V or smaller than 2 V is inputted to the operation signal sensing terminal SV4, the central control unit 20 outputs an OFF control signal (a low signal) to the first and second gate output terminals A, B and then stops the outputs of the first and second gate output terminals A, B so that the process stops.

In an embodiment of the present disclosure, by including the above-described configuration of the first and second power control elements FET1, FET2 serially connected, the output control units 14, 15 may safely cut off the heating circuit even if any one of the power control elements is short-circuited.

Hereinafter, the operation of the heating controller is described with reference to FIG. 1, with the resistance values of the sixth distribution resistor R6 and the seventh distribution resistor R7 distributed with the ratio of 21.5:2.5.

Electric current flows to the heating wire HW1 by alternatingly turning on FET1 and FET2 for the normal heating period of 400 ms and turning off FET1 and FET for the subsequent temperature sensing period of 20 ms. Since the other side terminals of FET1 and FET2 are connected to the ground for the heating period of 400 ms when FET1 and FET2 are turned on, the ground potential of 0 V will be shown at the operation signal sensing terminal SV4. During the subsequent temperature sensing period of 20 ms, when the first power control element FET1 and the second power control element FET2 are turned off, 24 V of voltage will be applied to the one side terminal of the sixth distribution resistor R6 and the other side terminal of the seventh distribution resistor R7. In the case of a normal operation with the resistance values of the sixth distribution resistor R6 and the seventh distribution resistor R7 distributed with the ratio of 21.5:2.5, the monitor voltage of the operation signal sensing terminal SV4 inputted to the central control unit 20 will be 2.5V.

If the first power control element FET1 is internally short-circuited, the sixth distribution resistor R6 will have been also short-circuited by the parallel-connected first power control element FET1, and thus 24 V of pulse voltage is applied to either end of the seventh distribution resistor R7 for 20 ms, and accordingly the maximum voltage of 5 V is inputted by the second central control unit protection circuit for the monitor voltage of the operation signal sensing terminal SV4. By determining that a voltage exceeding 3 V has been inputted to the operation signal sensing terminal SV4 and allowing the first and second gate output terminals A and B to output an OFF control signal (a low signal), the central control unit 20 may turn the second power control element FET2 off to cut off the supply of DC power to the heating wire HW1.

Moreover, if the second power control element FET2 is internally short-circuited, the seventh distribution resistor R7 will have been also short-circuited by the parallel-connected second power control element FET2, and thus 0 V, which is the ground potential, is inputted to the operation signal sensing terminal SV4.

By determining that a voltage smaller than 2 V has been inputted to the operation signal sensing terminal SV4 and controlling the first and second gate output terminals A and B to output an OFF control signal (a low signal), the central control unit 20 may turn the first power control element FET1 to cut off the supply of DC power of the heating wire HW1.

Moreover, since the first power source (DC+) is cut off when the heating wire HW1 is short-circuited, the ground potential 0 V is inputted to the operation signal sensing terminal SV4. In such a case, the central control unit 20 determines that a voltage smaller than the normal range of monitor voltage is inputted to the operation signal sensing terminal SV4 to control the first and second gate output terminals A and B to output an OFF control signal (a low signal) and then subsequently stops the process and simultaneously controls the LED of the display unit 16 to flicker in the form of a warning. Therefore, the use may immediately recognize the failure situation.

As described above, the heating controller of the heating device using DC power in accordance with an embodiment of the present disclosure can perform a precise temperature control by accurately sensing the variation of temperature throughout the entire section of the heating wire.

Moreover, the heating controller of the heating device using DC power in accordance with an embodiment of the present disclosure can quickly detect a local overheating, a spiral contact caused by a rupture in insulation of the heating wire, or a failure caused by a short-circuit of the heating wire to cut off the circuit and provide a warning means by flickering the LED, thereby protecting the heating device safely.

1. A heating controller for a heating device using DC power source,
wherein a heating cable of the heating device comprises:
a heating wire covered with a temperature sensitive insulating resin and configured to be heated by the DC power source; and
a heat sensing wire on which the temperature sensitive insulating resin is spirally wound on an exterior thereof,
wherein the heating controller is configured to:
alternatingly have a heating period, in which the heating wire is heated by supplying DC power to the heating wire through a power control element, and a temperature sensing period, in which a temperature sensing current is generated by supplying a pulse signal voltage to the heating wire; and
receive a temperature sensing voltage signal by the temperature sensing current flowing in the heat sensing wire through the temperature sensitive insulating resin by the pulse signal voltage in the temperature sensing period, and control a heating temperature of the heating device by controlling the power control element in the heating period according to the received temperature sensing voltage signal.

2. The heating controller of claim 1, wherein the heating controller is configured to output an OFF/ON output signal to a gate of the power control element at least once in the temperature sensing period to turn the power control element off and on to generate the pulse signal voltage.

3. The heating controller of claim 1, wherein the temperature sensing period is carried out for 15 to 30 ms every 300 to 1,000 ms.

4. The heating controller of claim 1, comprising:
a temperature sensing signal unit configured to sense a temperature sensing current, in which the pulse signal voltage flows to the heat sensing wire through the temperature sensitive insulating resin, to form a temperature sensing signal voltage;
a temperature sensing control voltage conversion unit configured to amplify a signal current inputted from the temperature sensing signal voltage of the temperature sensing signal unit to generate a temperature sensing control voltage;
an output control unit including the power control element configured to control a supply of the DC power supplied to the heating wire; and
a central control unit configured to transfer a control signal for the heating period and the temperature sensing period to the power control element according to a programmed process and receive the temperature sensing control voltage of the temperature sensing control voltage conversion unit to turn the power control element of the output control unit on and off.

5. The heating controller of claim 4, wherein the temperature sensing signal unit is configured to have one side terminal (S1) and the other side terminal (S2) of the heat sensing wire connected each other at a first sensing node (SV1) and to have a first voltage generating condenser connected between the first sensing node (SV1) and a first terminal node (nd1) connected to the other side terminal of the heating wire, wherein the temperature sensing signal voltage is formed at the first voltage generating condenser according to a heating temperature of the heating wire.

6. The heating controller of claim 5, wherein the first voltage generating condenser has a capacitance that is about 100 to 1,000 times greater than a capacitance of the temperature sensitive insulating resin.

7. The heating controller of claim 5, wherein the temperature sensing control voltage conversion unit is connected to a second power source (DC−) through a third distribution resistor (R3) serially connected with a second distribution resistor (R2) via an input terminal diode (D2) from the first sensing node (SV1),
wherein a connection point with the second distribution resistor (R2) and the third distribution resistor (R3) is connected with a base of a current-amplifying first transistor (TR1),
wherein a collector of the current-amplifying first transistor (TR1) is connected with a first power source (DC+) of the DC power source through a fourth resistor (R4),
wherein an emitter of the current-amplifying first transistor (TR1) is connected to the second power source (DC−) via a fifth resistor R5 to which a second condenser (C2) is connected in parallel,
wherein an emitter of the current-amplifying first transistor (TR1) is inputted to a temperature sensing voltage terminal of the central control unit, and
wherein the central control unit is configured to turn the power control element off if a temperature sensing control voltage inputted to the temperature sensing voltage terminal is determined to be higher than a predetermined temperature voltage.

8. The heating controller of claim 7, further comprising an operating power source unit configured to supply a DC operating power to an internal temperature control circuit,
wherein temperature sensing control voltage conversion unit is configured to connect a +5 V terminal of the operating power source unit to a connection point of the emitter of the current-amplifying first transistor (TR1) and the second condenser (C2) through a third diode (D3) for protecting the central control unit,
and wherein the central control unit is configured to turn the power control element off if a temperature sensing voltage inputted to the temperature sensing voltage terminal is higher than or lower than a predetermined range of normal input voltage of 0.2 to 4.8 V and then to control the power control element to stop outputting so as not to restart.

9. The heating controller of claim 4, wherein a one side terminal (H1) of the heating wire is connected with a first power source (DC+) of the DC power source, and
wherein the other side terminal (H2) of the heating wire is connected with a one side terminal of a first power control element (FET1) of the output control unit, and the other side terminal of a second power control element connected serially with the other side terminal and the one side terminal of the first power control element is connected with a second power source (DC−).

10. The heating controller of claim 9, wherein gates of the first power control element and the second power control element are connected, respectively, to gate output terminals (A, B) of the central control unit,
wherein a sixth distribution resistor (R6) is connected to either terminal of the first power control element, and a seventh distribution resistor (R7) is connected to either terminal of the second power control element, and a connection point 2 to which the sixth distribution resistor (R6) and the seventh distribution resistor (R7) are connected is connected with an operation signal sensing terminal (SV4) of the central control unit,
wherein the connection point 2 is connected to a +5 V terminal of the operating power source unit via a fourth diode (D4), and resistance values of the sixth distribution resistor (R6) and the seventh distribution resistor (R7) are distributed in such a way that a monitor voltage of the connection point 2 is set in a range of 1 to 4 V in a normal temperature sensing period,
wherein if a voltage that is greater or smaller than a predetermined range of normal monitor voltage is inputted to the operation signal sensing terminal (SV4) in the temperature sensing period, the central control unit is configured to output an OFF control signal through the gate output terminals (A, B) and then to control the gate output terminals (A, B) of the central control unit to stop outputting so as not to restart.
